(19) United States
(12) Patent Application Publication
(10) Pub. No.: US 2011/0301879 A1
(43) Pub. Date: Dec. 8, 2011

(54) Pressure sensor, valve assembly and method for their operation

(75) Inventors: Manfred Herbst, Nurnberg (DE); Markus Schwarz, Treuchtlingen (DE); Markus Stephan, Gnotzheim (DE); Jean-Francois Tirlet, Armancourt (FR)

(73) Assignee: Alfmeier Prazision AG Baugruppen und Systemlosungen, Treuchtlingen (DE)

(21) Appl. No.: 13/043,656

(22) Filed: Mar. 9, 2011

(30) Foreign Application Priority Data
Mar. 9, 2010 (DE) 10 2010 002 710.3
May 6, 2010 (DE) 10 2010 028 708.3

(51) Int. Cl. G06F 19/00

(52) U.S. Cl. 702/50

(57) ABSTRACT

A pressure sensor (10) comprises a pressure transducer (12) that generates an electric pressure signal (28) in correlation with an absorbed pressure (p) and a processing unit (23) that generates an electric output signal (S) by means of a mapping rule (35) from the pressure signal (28).

A valve assembly (2) contains a pressure sensor (10) that records a pressure (p) in its interior space (11) and emits it as a pressure signal (S).

In a method for operating a pressure sensor (10), a pressure transducer (12) generates an electric pressure signal (28) in correlation with an absorbed pressure (p), and a processing unit (23) generates an electric output signal (S) by means of a mapping rule (35) from the pressure signal (28).

The invention refers to a pressure sensor for a vehicle, a valve assembly containing that pressure sensor and a method for operating such a pressure sensor or valve assembly.

Most vehicles nowadays have many pressure sensors. They absorb a pressure to be measured and emit the absorbed or measured pressure as an electric signal, which they transmit to vehicle components for further processing. Pressure sensors are also built into valve assemblies. For example, non-return valves as valve assemblies with an integrated pressure sensor (here in the form of a vacuum sensor) are integrated between a vacuum reservoir and a vacuum source of a braking force booster. When the vacuum source is turned off, the non-return valve prevents a vacuum loss, i.e. an inward flow of air into the reservoir. In other embodiments, the pressure sensors are not integrated in the valve assembly, but as so-called “stand-alones” intended as individual components or combined in a vacuum reservoir.

Pressure sensors are nowadays known that deliver an analog output signal (e.g. an electric voltage ranging from 0 to 5 V) correlated with the measured pressure. Other typical voltage ranges are 0-12 V, 3-3.3 V, 0-42 V, etc. Actually, these are pure pressure absorbers: The electric signal is thus an electric pressure signal generated directly by the pressure transducer. The pressure signal is then led, for instance, to a central control unit located in the vehicle for evaluation. The relationship between pressure and pressure signal is determined solely by the pressure transducer and depends from temperature fluctuations, among other things. With the help of the intensity of the voltage intensity delivered by the pressure sensor or transducer, an electric switching function is triggered in the vehicle, for example. The central control unit, for instance, decides what measures must be taken to compensate for an excessively low measured vacuum. In the example of the braking force booster given above, in a hybrid vehicle, for example, the internal combustion engine of the vehicle or an electrical additional vehicle pump are started as vacuum sources for generating or post-strengthening a vacuum in the vacuum reservoir.

Alternatively, pressure sensors designed as mechanical switching systems are known. Depending on the pressure to be absorbed, they generate a binary electrical output signal—for example, a “0” signal with 0 V or a “1” signal with 5 V. For this reason, they are also known as pressure switches. Generally, they contain a spring and membrane acting as pressure transducer. This pressure transducer activates an electric switching element that can be a spring-controlled switch. The membrane is therefore supported by a spring, loaded by the pressure to be measured and moves according to the pressure or vacuum applied. If a pressure exceeds or falls below a certain level, it activates the spring-controlled switch, which then delivers an electric (generally binary) signal: a “0” signal for 0 V or a “1” signal for 5 V or 12 V, for example. The generated electrical signal is once again, as described above, transmitted to a central control unit for further evaluation.

It is also conceivable for pressure sensors (especially for the pressure switches mentioned above) to pass on the resulting electrical signal directly to an electrical power consumption device, i.e. a vacuum pump, an electromagnetic valve or something similar. In other words, the pressure sensor itself will in that case act as a pressure-actuated switching element directly on the connected component.

The electromechanical pressure sensors mentioned are subject to physical limitations: For example, in the binary pressure sensor switch mentioned above, the positioning of the spring-controlled switch with respect to the membrane allows the arbitrary or sufficient adjustment to a certain limit pressure (i.e. the transition from a “1” to a “0” signal can take place with a certain pressure). However, the second switching point or pressure (i.e. the transition from a “0” to a “1” signal) must therefore necessarily take place inside the system owing to the mechanical dimensions of the spring-controlled switch or the elastic properties of the membrane and the pressure spring, for example, and therefore cannot be freely selected any longer. In other words, the hysteresis properties of the pressure sensor—especially in the case of the pressure sensor mentioned above—cannot be freely and easily selected; they can at most be influenced up to a point by complicated construction designs.

Additionally, the known pressure sensors need large tolerance windows with respect to the dimensioning of their switching points or the pressures to be monitored because switching points or characteristic lines change between pressure and output signal when temperatures fluctuate. For example, the membrane mentioned above is elastomeric and its output signal is affected by the determining properties that are greatly influenced by a −20° C. to +100° C. temperature range. Additionally, corresponding systems are generally not capable of diagnosis; in other words, the pressure sensors cannot generate or send a diagnosis signal regardless whether they are functioning perfectly or not.

Attempts to better adjust the switching points mentioned above, for example, or to integrate a diagnosis capability in existing pressure sensors are generally impossible, very costly or under certain circumstances mean a high production waste.

The task of the invention is to suggest an improved valve assembly and an improved method for operating it.

As far as the pressure sensor is concerned, the task is solved by a pressure sensor in accordance with patent claim 1. The pressure sensor contains a pressure transducer that generates an electrical or digital signal from an absorbing pressure in correlation with it. The pressure sensor also contains a processing unit that generates an electric output signal by means of a mapping rule.

Expressed in another way, a (generally electronic) pre-processing of the electric signal (i.e. of the pressure signal) generated by the pressure transducer already takes place inside the pressure sensor. Consequently, a decoupling of the output signal from the pressure transducer's system-inherent characteristics determines the characteristics of the pressure signal. Depending on the design of the mapping feature, the pressure signal can be represented in almost any way on the output signal.

The invention is based on the insight that the pressure sensors used until now always contain the actual pressure transducer that generates an electrical signal dependent on the pressure and this signal is directly emitted by the pressure sensor. The invention is therefore based on the fundamental concept that the electrical signal that the pressure transducer generates is no longer emitted directly (i.e. unfiltered) to the central vehicle control mentioned above or to the corresponding power-consuming device, for example. According to the invention, the pressure or sensor signal should already be locally pre-processed by the processing unit (i.e. within the pressure sensor) in an electronic way with the help of the mapping rule. The processing unit can be an evaluation circuit. Only the pre-processed signal—in other words, the output signal of the evaluation circuit—can be transmitted to the central processing unit or the power-consumption device, for instance.

In accordance with a favorable embodiment, the processing unit is a microcontroller. A program working within this microcontroller then carries out the mapping rule, at least partially. An additional implementation of the mapping rule then takes place, for example, via the characteristic lines of non-linear components or partial circuits connected downstream from the pressure transducer. Alternatively, the processing unit is a discrete circuit whose dimensioning implements the mapping rule.

Thus, in the pressure transducer there is a pressure sensor on a printed circuit board and this transducer delivers an output signal proportional to the pressure as an analog output voltage, the pressure signal. An analog/digital converter with a correspondingly high bit resolution of 10 bits, for example, converts this output voltage to a digital signal, which is then further processed with a microcontroller and software installed in it as processing unit. The signal is thus modified, and this modified signal is emitted by the pressure sensor as an output signal, digitally or analogically reconverted. In this case, the A/D or D/A converter can also be directly integrated into the microcontroller. In other words, the analog output signal of the pressure sensor is then led directly to an analog input of the microcontroller.

In another preferred embodiment, the mapping rule is modifiable. For example, the microcontroller can be programmed or loaded with different programs that represent various mapping rules.

Thus, a characteristic line adaptation of a currently selected pressure transducer is conceivable in the pressure sensor so that the continuous (i.e. analog output signal, for example) is equal in spite of the different internal pressure transducers.

In a further embodiment, the output signal is a pressure-dependent logic signal that accepts at least two switching states. Also conceivable are more switching states of the signal that can then be encoded in a single output signal, for instance. The corresponding microcontroller software will then, for example, decide whether a logical “1” or “0” signal is generated at the output of the microcontroller. In other words, it checks the pressure signal for adherence to the switching thresholds programmed in the microcontroller. The change from one switching state to the other therefore takes place on a respective switching point.

In an advantageous embodiment, the pressure sensor contains a changeable switching point that determines a change between two switching states in the output signal. In other words, the pressure level in which the pressure sensor operates (i.e. the value in which the output signal changes) is adjustable. By processing the pressure signal delivered by the pressure transducer in the microcontroller, the corresponding pressure switching thresholds of the pressure sensor can be executed arbitrarily—for example, programmable in the microcontroller.

In a favorable embodiment, the pressure sensor contains a first switching point that reacts on a pressure increase and a second switching point that reacts on a pressure decrease. Because of this, the pressure sensor's hysteresis feature is freely programmable or determinable. The switching thresholds—and therefore the pressure sensor's hysteresis features too—can be easily and freely changed by reprogramming the micro-controller, for example.

In a favorable embodiment, the pressure sensor contains a processing unit with several outputs for different (i.e. two or more) output signals. Every output signal by itself can be constituted in almost any possible way—for example, an analog and various binary output signals can be generated.

For instance, each of the several outputs of the pressure sensor has its own, generally different signal. All signals to be emitted are based on the same sensor signal (i.e. pressure signal) but have generally been preprocessed differently within the pressure sensor. For example, different pressure thresholds or pressure levels have been programmed in the pressure sensor and—depending on whether the different pressure levels are exceeded or fall under a certain value—different outputs of the pressure sensor are activated or deactivated.

If the outputs are, for example, those that can directly control power-consuming devices, then several of them can be controlled from one single pressure sensor via every one of its outputs. For example, the pressure transducer would then monitor the reservoir vacuum level of a vehicle's braking force booster. Depending on the respective pressure, different power-consuming devices or aggregates such as air conditioning, electrical auxiliary pumps, etc. can be switched on or off directly to react differently to the current vacuum level.

In a preferred embodiment, the pressure sensor contains a power driver for amplifying the output signal. Through this, the direct control of a power-consuming device mentioned above can take place with a powerful output signal. The output signal can then be interconnected through this indirect route to the vehicle's electronic system but also to a directly controlled power-consuming device. The output signal delivered by the sensor is. Thereby, the pressure sensor can be used like a typical, pressure-actuated switch, pressure sensor or pressure switch used so far. For example, by connecting the pressure sensor in series between the on-board voltage and a vacuum pump, it can be directly operated without further interconnection of the vehicle's electronics, a relay or similar device.

In an additional embodiment, the pressure sensor contains a correction unit that records a disturbance variable that influences the correlation between the pressure and the pressure signal and also corrects the output signal depending on the disturbance variable with regard to it. In this case, the correction unit acts on the pressure signal, the output signal or the processing unit located in between, for example.

By utilizing such wiring in the actual pressure transducer, temperature influences acting on the pressure transducer can be reduced with the temperature as disturbance variable. Through adequate processing in the microcontroller, a correction of the measured value for the pressure is carried out by measuring the temperature, for example, thus compensating for the temperature influences in the pressure sensor. The micro-controller can thus also carry out complex corrections on the pressure signal, for example by implementing temperature compensation by means of a characteristic line.

In a further embodiment, the pressure sensor contains a diagnosis module that monitors the functioning of the pressure sensor and emits an error signal, which will then be available in a separate diagnosis output, for instance. The diagnosis information can also be contained in the generated output signal, however. For example, the diagnosis module can be integrated into the microcontroller as a program. If the microcontroller generates output signals between 0 V and 5 V, for example, it will generate in a faultless operation always a minimum voltage of 0.5 V and a maximum voltage of 4.5 V. Both ranges between 0 V and 0.5 V and between 4.5 and 5 V are not used if the pressure sensor runs faultlessly. If, on the other hand, the microcontroller diagnoses an error (a break-down of the pressure transducer, for instance), it utilizes the otherwise unused voltage ranges and emits signals from 0 to 0.3 V or 4.7 to 5 V, for example. A further processing control recognizes the voltage changes and implements additional measures (a warning message, for instance). In this way, errors in the pressure sensor can be detected such as a breakdown of the pressure sensor, an excessively high surrounding temperature, a sharp drop in the voltage supply or similar things.

In another embodiment of the pressure sensor according to the invention, there are additional components for adapting it to vehicle use conditions such as rough surroundings, for example. A few examples are: reverse battery protection, short-circuit protection, electromagnetic compatibility measures, etc.

In another embodiment of the invention, the pressure sensor can be executed as an absolute pressure sensor or differential pressure sensor by selecting suitable microcontroller software. An absolute pressure sensor always measures the absolute pressure applied on the pressure sensor, whereas the differential pressure sensor measures a pressure that refers to the atmospheric pressure that is momentarily prevailing outside of the vehicle, for example.

The pressure sensor according to the invention can be equipped with any pressure transducer. In another preferred embodiment of the invention, the pressure sensor is equipped with a pressure transducer that delivers a digital signal (e.g. 10 bits), instead of an analog output signal, and therefore an A/D conversion such as the one discussed above could be economized. In other words, a complex pressure transducer is used that already has a basic intelligence in the form of a simple microcontroller, for instance.

In another advantageous embodiment, the entire pressure sensor is fully integrated. This creates a pressure sensor in which at least the essential components (microcontroller, installed software, additional wirings, etc.) or also the entire evaluation electronics mentioned above are integrated in one single substrate. Thus, a programmable (more error tolerant and diagnosis-capable, for example) pressure sensor is created in which the switch signal is finally captured in the usual way so it can be passed on to the other vehicle components.

In another favorable embodiment of the invention, the pressure sensor is designed so it can function with the generic voltage the vehicle needs, for example with 5 V, 12 V or 42 V, i.e. with the corresponding on-board voltage. The voltage switch-over in the sensor can also be configured or programmed in the microcontroller. To do this, a fixed voltage regulator is integrated in the pressure sensor for adapting a pressure transducer that works separately on 5 V to an operating voltage level of 12 V or 42 V, for example. Instead of the integration, however, an external fixed voltage regulator can also be used for heat technology reasons. In that case, merely the corresponding feed line for the voltage supply remains to be installed on the pressure sensor.

In a further embodiment of the invention, the sensor's hardware setup is designed so flexibly that the same hardware is always used for the respective application and various pressure sensors for different applications differ from one another only by the software used in the sensor.

In another embodiment, the pressure sensor module according to the invention has a flexible housing concept so that the pressure sensor can be integrated to the most varied assemblies with one or several non-return valves, for example.

In another embodiment of the invention, the pressure sensor is bus-compatible. In this case, the pressure sensor makes the generated output signal available to a CAN-, SENT- or LIN-BUS, for example.

Regarding the valve assembly, the task is solved using a valve assembly in accordance with patent claim 11. Inside, it contains a pressure sensor according to the invention for recording pressure that also emits a pressure signal. Thus, the pressure sensor according to the invention is integrated into the non-return valve mentioned above. The advantages of the pressure sensor mentioned above impact the corresponding advantages of the no-return valves. In this way, the pressure transducer signals are evaluated inside the non-return valve.

Non-return valves get a freely programmable pressure switching behavior, are temperature-compensated, get diagnostic capability or can be used in exchange for conventional valves. They can deliver analog or digital output signals, can be configured for different on-board voltages and used in a flexible housing concept for non-return valves.

Regarding the method, the task is solved by a method for operating a pressure sensor according to the invention in accordance with patent claim 12. The pressure transducer generates an electrical signal in correlation with a pressure to be absorbed. With the help of a mapping rule, a processing unit generates an electric output signal from the pressure signal.

The method and its advantageous further designs plus their advantages were already explained above.

The reader should refer to embodiment drawings for a further description of the invention. They show, in each case in a schematic sketch:

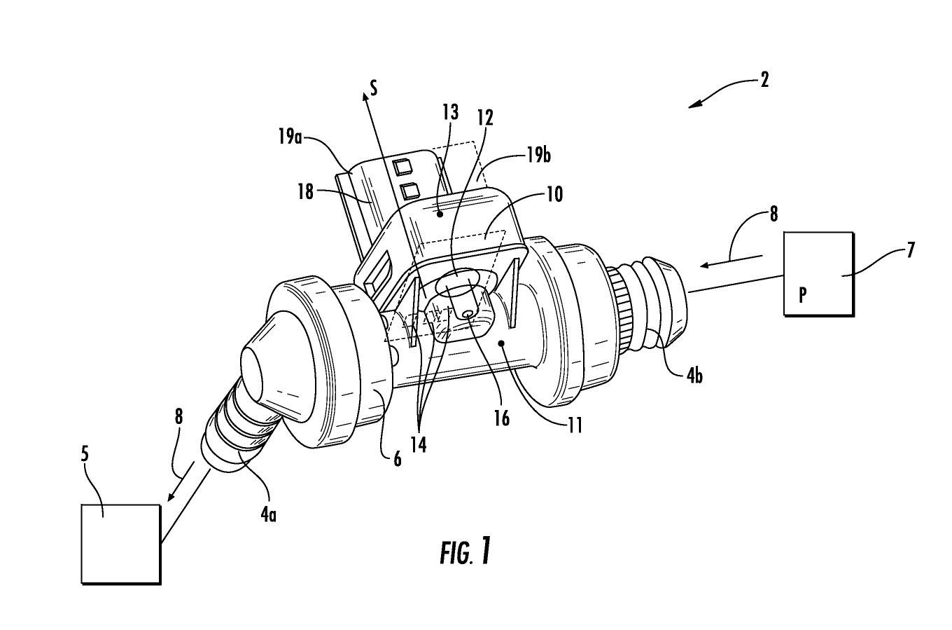

FIG. 1 a non-return valve with a pressure sensor according to the invention,

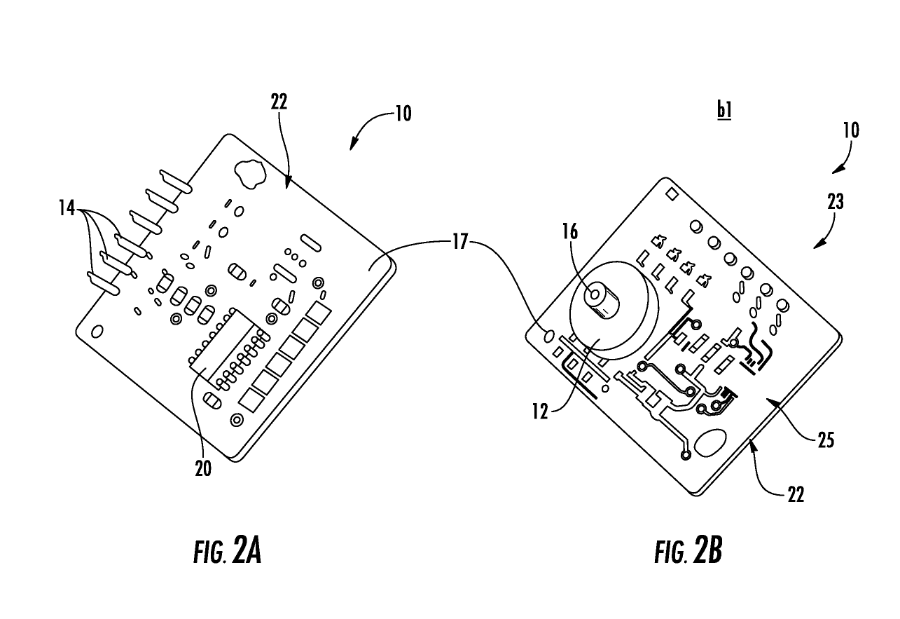

FIG. 2 a top view (a) and a bottom view (b) of the pressure sensor shown in FIG. 1,

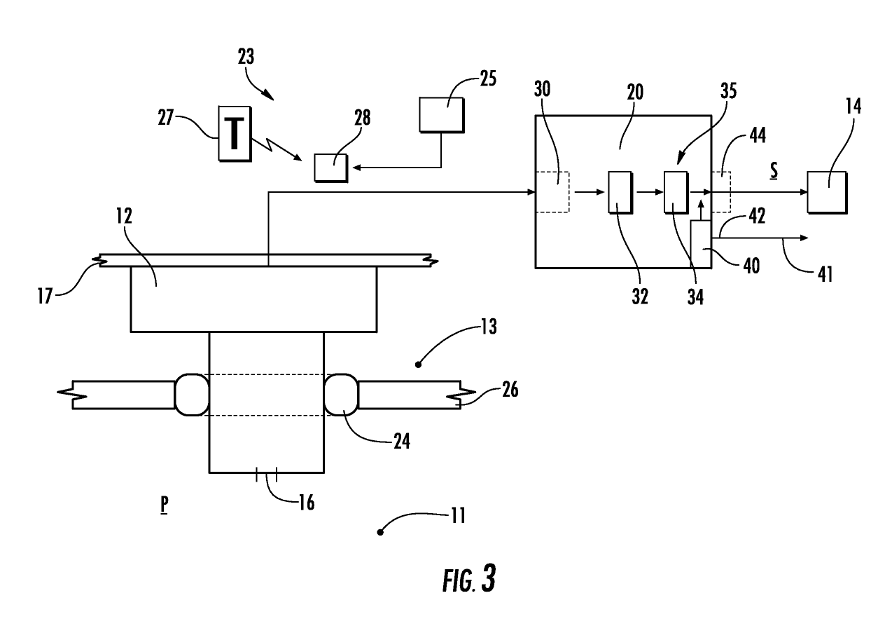

FIG. 3 a block schematic diagram of the pressure sensor from FIG. 1,

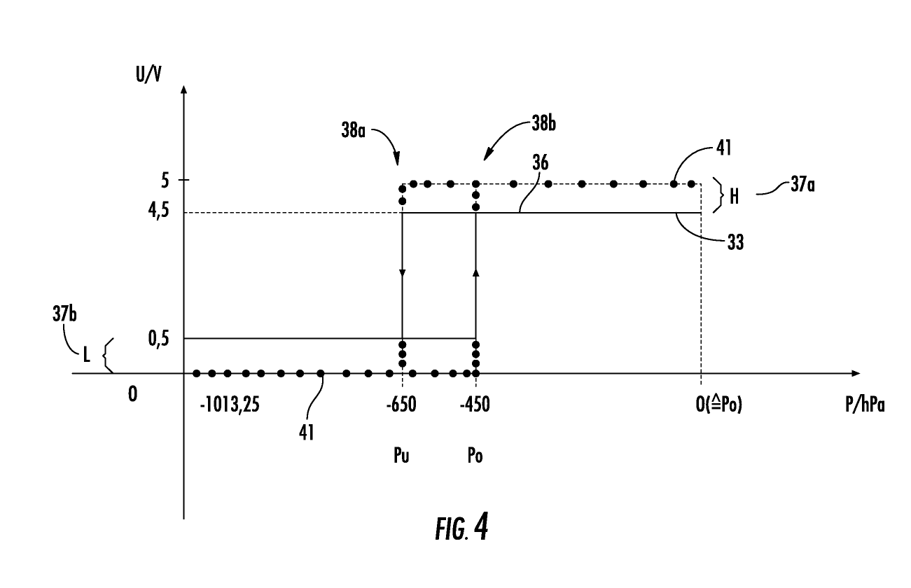

FIG. 4 a characteristic line of the pressure sensor from FIG. 1,

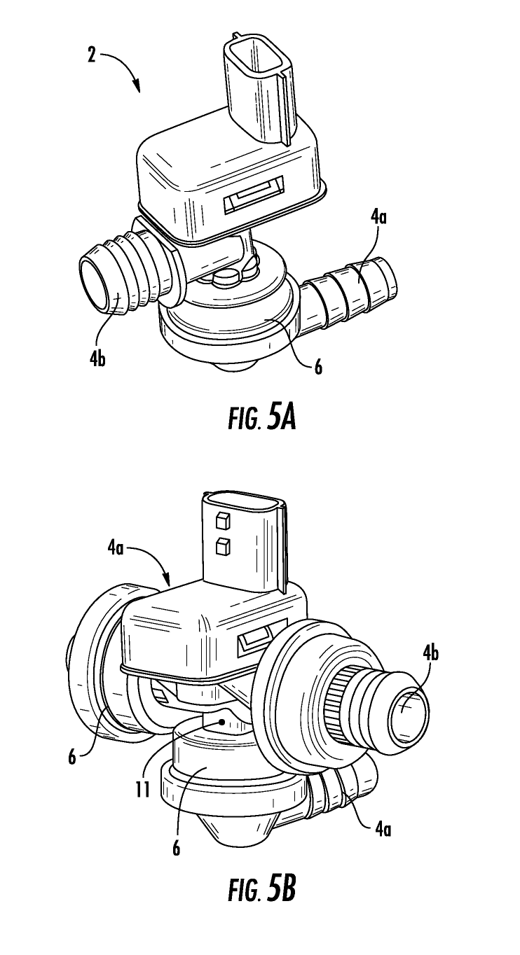

FIG. 5 alternative non-return valves with pressure sensors according to the invention.

FIG. 1 shows a valve assembly 2, also known by the short name of “non-return valve” that can be built into a vehicle not shown here. In the built-in state (merely sketched in FIG. 1), a first connecting piece 4a of the valve assembly 2 leads to a vacuum source 5, which can be the vehicle's engine or an electric vacuum pump. A second connecting piece 4b leads to a storage container 7 that can be vacuum reservoir of a braking force booster.

Furthermore, in the valve assembly 2 an actual non-return valve 6—in FIG. 1 likewise only indicated—has also been integrated in the pressure path between the two connecting pieces 4a,b. The valve assembly 2 thus makes it possible for air to be sucked out of the storage container 7 in the direction of the arrows 8 towards the vacuum source 5 so that, for example, a vacuum can be generated in the storage container 7. Here, the non-return valve 6 opens to allow pressure to be compensated or air to flow in the direction of the arrows 8. If the vacuum source 5 is turned off, the non-return valve 6 closes and the vacuum in the storage container 7 is blocked off and no air can flow against the arrows 8 back to the storage container 7.

The valve assembly 2 also contains a pressure sensor 10 (only indicated in FIG. 1) connected in a pressure-sensitive way to an interior space 11 of the valve assembly 2 that communicates with the connecting pieces. Thus, the pressure sensor 10 records the vacuum or pressure p existing between the non-return valve 6 and the storage container 7—and therefore also in the storage container 7. The pressure sensor 10 generates an electric output signal S correlated with the pressure p. This pressure sensor 10 comprises, in particular, a pressure transducer 12 sealed towards an exterior space 13 of the valve assembly and a sensing device opening 16 that corresponds to the pressure p in the interior space 11, as described above. The pressure sensor 10 also has electric contacts 14 that emit the recorded pressure in the form of an output signal S through a plug-in connection 18 of the valve assembly 2, creating with it an output 19a for the output signal S. In an alternative embodiment, the pressure transducer generates various output signals S. Another output signal is then emitted in a second output 19b. The contacts 14 also supply electric energy to the pressure sensor 10.

FIG. 2 shows a detailed view of the pressure sensor 10, which has the following components shown: An electronic switching printed circuit board 17, in accordance with FIG. 2a a view of its upper side, in accordance with FIG. 2b a view of its underside. The printed circuit board 17 is fitted with the pressure transducer 12 and the electric contacts 14. A microcontroller 20 and more electronic construction elements 22 interconnected with the components mentioned above have also been arranged on it. The construction elements 22 carry out level adjustments, temperature compensation, EMC protection, electric signal power amplification, etc. The construction elements 22 together with the microcontroller 20 form one processing unit 23.

FIG. 3 shows a schematic block diagram of the pressure sensor 10. The pressure transducer 12 has been integrated in such a way in a housing wall 26 of the valve assembly 2 with the help of a seal 24 that only its sensing device opening 16 communicated with the interior space 11 and thus with the pressure p. The rest of the pressure transducer 12 is located together with the printed circuit board 17 in the exterior space 13 on the surrounding pressure level. The pressure transducer 12 generates a pressure p-dependent output signal, namely the electric pressure signal 28, in the form of an analog signal—for example—that is then transmitted to the microcontroller 20. In an A/D converter 30, the pressure signal 28 from the microcontroller 20 is then converted to a digital or logical signal 32 that is generally several bits wide. In an alternative embodiment (not shown), a separate A/D converter located outside of the microcontroller can also be used instead.

A program 34 inside the microcontroller 20 processes the pressure signal 28 further. The program 34 generates the output signal S of the microcontroller 20, in order to lead it to the contacts 14 and from there to the vehicle components (not shown) for further processing. The program carries out at least part of a mapping rule 35 that represents the pressure signal 28 on the electric output signal S or generates it from the pressure signal 28. The mapping or representation is made possible by the processing unit 23.

In an advantageous embodiment, the processing unit 23 also has a correction unit 25, executed using a part of the construction elements 22. The correction unit records a temperature T in the interior space 11. The temperature T is a disturbance variable 27 that influences the relationship between pressure p and pressure signal 28. For this reason, the correction unit corrects the pressure signal 28 depending on the temperature T so that the same pressures p always correspond to the same values of the pressure signal 28. In this case, the correction unit 27 brings about a part of the mapping rule 35.

Both signals are thereby, as a rule, different—especially even if both signals are analogically designed, in which case they form different characteristic lines with regard to pressure p and value of the output signal S.

FIG. 4 shows a characteristic line or mapping rule created by the program 34: In accordance with it, the pressure signal 28 or the logical signal 32 is converted to or represented in the output signal S. Thus, the pressure transducer 12 generates at first the pressure signal 28, which the A/D converter 30 simply digitalizes. The signal 32 is therefore just the pressure p (which the pressure transducer 12 has recorded and converted to a numerical value), standardized as differential pressure to the current surrounding pressure p₀. The output signal S is represented by a voltage within the range of 0 V and 5 V and supposed to indicate whether the current pressure p lies above (H level) or below (L level) a limit pressure. The output signal is therefore a logic signal 33 that can accept at least two switching states 37a,b, namely levels L and H as a rule.

Program 34 creates a characteristic line 36 in such a way that a logical H level of 4.5 V is generated as output signal S between a differential pressure of 0 hPa and −650 hPa. If the pressure p drops below a lower limit pressure pᵤ of −650 hPa, the signal S switches to the logical L level of 0.5 V. Thus, the limit pressure pᵤ constitutes a first switching point 38a allocated to the falling pressure p for the output signal S. In an embodiment not shown, the output signal S jumps back once again to the H level when the same limit pressure pᵤ is exceeded.

In the embodiment shown, the characteristic line 36 programmed in the microcontroller 20 also contains a hysteresis function, however. If the pressure p rises again, the L level in the output signal S increases again to an H level, only starting at an upper limit pressure pₒ of −450 hPa. This limit pressure thereby constitutes a second switching point 38b different from the first 38a. In this case, the respective lower and upper limit pressures pᵤ and pₒ can also be changed (i.e. programmed) independently from one another by changing the parameters in program 34.

FIG. 4 also shows that a diagnostic capability is integrated in the pressure sensor 10 through the characteristic line 36. To do this, a diagnosis module 40 (see FIG. 3) here in the form of an additional program in the microcontroller 20, has been integrated in the pressure sensor 10. If the diagnosis module 40 detects an irregularity in the pressure sensor 10, the pressure sensor 10 emits the values of 5 V or 0 V (shown as dotted lines in FIG. 4) in the output signal S as logical levels H or L. These values thereby create an error signal 41 or encode it in the output signal S.

An irregularity can be a suspected breakdown of the pressure transducer 12 or the exceeding of a limit temperature on the printed circuit board 17. From the discrepancy detected in the regular values of the levels H and L of 4.5 V and 0.5 V during regular operation, a vehicle control (not shown) receiving the signal S concludes that there is an error in the vacuum sensor 10. The error information is therefore integrated in the corresponding H and L and in the output signal S. Alternatively, however, the pressure sensor can also have a separate output 42 on which then a logic error signal 41 is emitted.

In alternative embodiments (not shown), other voltages apply in FIG. 4 (e.g. 0.3 V instead of 0 V and 3V, 12 V or 42 V instead of 5 V). Additionally or alternatively, the characteristic line 36 runs inversely, which means that at −1013.25 hPa, for example, it takes a value of 12 V, at 0 hPa a value of 0 V.

FIG. 3 shows in an alternative embodiment yet another power driver 44 that amplifies the output signal S to directly control power-consuming devices (not shown) that need power.

FIG. 5 shows more embodiments of valve assemblies 2; those in FIG. 5a differ merely in the geometric design, not in the functionality of the valve assembly 2 from FIG. 1. It can thus be used for other installation space situations, for example.

In FIG. 5b, the corresponding valve assembly 2 has two different connecting pieces 4a for distinct vacuum sources 5. Every connecting piece 4a has its own non-return valve 6 that leads to the interior space 11 and therefore to connecting piece 4b. Thus, a vacuum can be generated either at the connecting piece 4b via one of the two connecting pieces 4a or the vacuum source connected to it, which is favorable for use in hybrid vehicles, for example. In them, their internal combustion engines are connected on the one hand to a connecting piece 4a and on the other hand an electric pump to the other connecting piece 4a. One or the other can be used alternatively.

1. Pressure sensor comprising:
a pressure transducer that, in correlation with a pressure to be absorbed, generates an electric pressure signal; and
a processing unit via a mapping instruction, generates an electric output signal from the pressure signal.

2. Pressure sensor according to claim 1, wherein the processing unit is a microcontroller that contains at least a partially executing program brought about by the mapping rule.

3. Pressure sensor according to claim 1, wherein the mapping instruction includes a changeable mapping instruction.

4. Pressure sensor according to claim 1, wherein the output signal is a logic signal that depends on the pressure and accepts at least two switching states.

5. Pressure sensor according to claim 4, wherein a changeable switching point is determined by a change between the two switching states.

6. Pressure sensor according to claim 4, wherein a first one of the switching points reacts to a pressure increase and a second switching point reacts to a pressure decrease.

7. Pressure sensor according to claim 1, wherein the processing unit has several outputs for different output signals.

8. Pressure sensor according to claim 1, further including a power driver that amplifies the output signal.

9. Pressure sensor according to claim 1, further including a correction unit that:
records a disturbance variable that influences the correlation between the pressure and the signal; and
corrects the output signal depending on the disturbance variable with respect to the disturbance variable.

10. Pressure sensor according to claim 1, further including a diagnosis module that monitors the functioning of the pressure sensor and emits an error signal.

11. Valve assembly with a pressure sensor according to claim 1, and that records a pressure in its interior space and emits it as a pressure signal.

12. Method for operating a pressure sensor according to claim 1, in which:
the pressure transducer generates the electrical pressure signal in correlation with the pressure to be absorbed; and
the processing unit generates the electric output signal by means of the mapping instruction from the pressure signal.

13. Method according to claim 12, wherein the pressure sensor generates, as the output signal, a logic signal that depends on the pressure and accepts at least two switching states.

14. Method according to claim 12, wherein the pressure sensor generates different output signals in several outputs.

15. Method according to claim 12, wherein the pressure sensor emits an error signal depending on the functioning of the pressure sensor.

16. Method according to claim 12, implemented via the valve assembly that records a pressure in its interior space and emits it as a pressure signal.
